(19) United States
(12) Patent Application Publication
(10) Pub. No.: US 2011/0227835 A1
(43) Pub. Date: Sep. 22, 2011

(54) TRANSPARENT TOUGH PANEL ASSEMBLY

(76) Inventor: Teh-Zheng Lin, Taoyuan (TW)

(21) Appl. No.: 12/724,426

(22) Filed: Mar. 16, 2010

(51) Int. Cl. G06F 3/041

(52) U.S. Cl. 345/173

(57) ABSTRACT

A transparent touch panel assembly includes stacking layers of a linearity polarizer film, a touch layer, a resistive touch sensing unit, a substrate, and a phase retardation film. The touch layer is a flexible transparent film having at least one surface thereof being processed by phase-coating. The substrate is a hard transparent glass. The resistive touch sensing unit is insulated arranged between the touch layer and the substrate. The touch panel assembly is arranged in front of a display. By half orthogonal angle between the axes of the linearity polarizer film and the phase retardation of the touch layer, reflections of the environment incident lights will be suppressed. By the phase retardation film arranged between the resistive touch sensing unit and a LCD display and an orthogonal angle between the axes of the phase retardation film and the phase retardation of the touch layer, a higher contrast will be achieved.

### FIELD OF THE INVENTION

The present invention relates to touch panel, and particular to a high contrast touch panel capable of lowering reflection.

### DESCRIPTION OF THE PRIOR ART

Touch panels are usually arranged in front of a display of electric devices so as to provide operation for the user. Touch panels are also easily influenced by environment such as outdoor sun light. The strong light will cause irregular reflections so that user can not see the display clearly.

### SUMMARY OF THE PRESENT INVENTION

Accordingly, the primary object of the present invention is to provide a transparent touch panel assembly having a polarizing plate on a surface to avoid reflection and at least one phase coating between the touch panel and a display to avoid color distortion.

To achieve above object, the present invention provide a touch panel assembly including a linearity polarizer film, a touch layer, a resistive touch sensing unit, a substrate, and a phase retardation film stacking in order. The substrate is a hard transparent thin plate made of material such as glass, polycarbonate (PC), polyester (PET), polymethyl methacrylate (PMMA), or Cyclo-Olefin Copolymers (COC). The touch layer is a flexible transparent film made of material such as polycarbonate (PC), polyester (PET), or Cyclo-Olefin Copolymers (COC). The touch layer is a thin layer processed by phase-coating having equivalent phase retardation effect. The resistive touch sensing unit is insulated arranged between the touch layer and the substrate. The touch panel assembly is arranged in front of a display. By half orthogonal angle between the axes of the linearity polarizer film and the phase retardation of the touch layer, reflections of the environment incident lights will be suppressed. However, by the phase retardation film arranged between the resistive touch sensing unit and a LCD display and an orthogonal angle between the axes of the phase retardation film and the phase retardation of the touch layer, a higher contrast will be achieved.

### BRIEF DESCRIPTION OF THE DRAWINGS

FIG. 1 is a partial cross-section view of the present invention.

FIG. 2 is a schematic view showing axes of layers of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

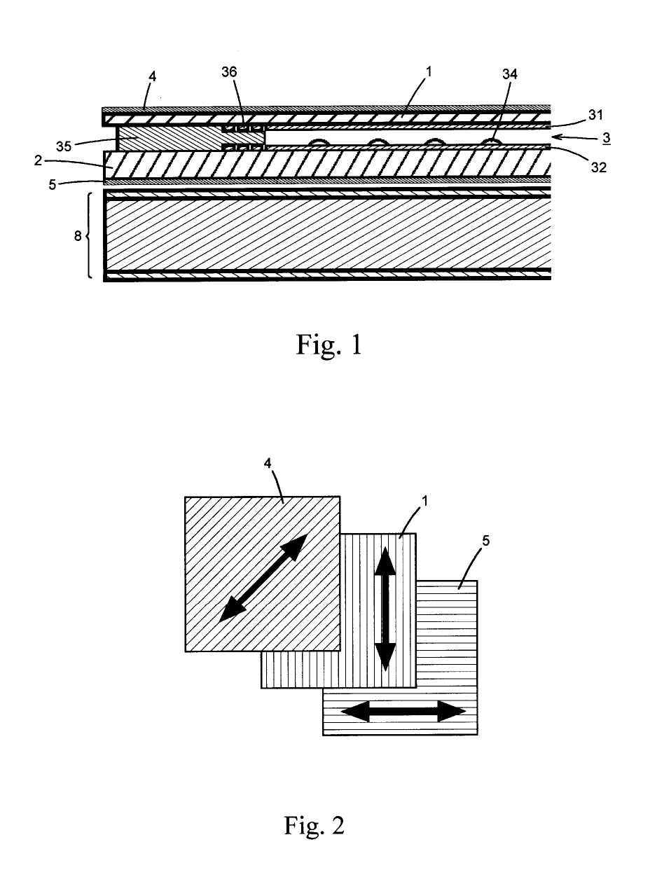

An embodiment of the present invention applied in a resistive touch panel is illustrated in FIGS. 1 and 2. The touch panel has a resistive touch sensing unit 3 arranged between a touch layer 1 and a substrate 2. A linearity polarizer film 4 is arranged above the touch layer 1. A phase retardation film 5 is arranged below the substrate 2. The touch layer 1 is a flexible transparent film, and is especially a processed thin layer from a phase-coating layer so that the touch layer 1 has the equivalent effect as the phase retardation film. The substrate 2 is a transparent glass. The touch sensing unit 3 has an upper conductive film 31 and a lower conductive film 32. The upper and lower conductive films 31, 32 are transparent Indium Tin Oxide (ITO) thin film. The upper conductive film 31 is arranged to a bottom surface of the touch sensing layer 1, and the lower conductive film 32 is arranged to an upper surface of the substrate 2. A plurality of protruding spacers 34 are arranged between the upper and the lower conductive films 31, 32 so as to separate the two conductive films within an effective area. A conducting wiring 36 is formed around the effective area. A gluing frame 35 is arranged outside the conducting wiring 36 to glue the touch sensing layer 1 and the substrate 2 together so that the conductive films 31, 32 will be sealed inside the stacking plates.

The above resistive touch panel is arranged in front of a LCD display 8. A voltage signal will be generated to the touch sensing unit 3 while a user touching the resistive touch panel by a finger or a tip of a pen. By sensing the variance of the voltage signal, the position pressed by the finger or the tip can be located so that the user could perform an interaction operation by message on the display. Moreover, by half orthogonal angle (45°) between the axes of the linearity polarizer film 4 and the phase retardation of the touch layer 1, incident linear polarizing light will become circular polarizing light or approximate circular polarizing light in the space of the touch panel. The reflection of the incident light will be suppressed by an orthogonal angle between the axes of the touch layer 1 and the top linearity polarizer film 4. However, by the phase retardation film 5 arranged between the resistive touch sensing unit 3 and the LCD display 8 and an orthogonal angle (90°) between the axes of the phase retardation film 5 and the phase retardation of the touch layer 1, a color distortion will be avoided so as to achieve a higher contrast. Therefore, such touch panel can still provide a fine display with high contrast outdoors or under strong sun light.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A transparent touch panel assembly comprising:
a linearity polarizer film;
a touch layer being a flexible transparent film; at least one surface thereof being processed by phase-coating; the linearity polarizer film being arranged above the touch layer;
a substrate being a hard transparent thin plate;
a resistive touch sensing unit being insulated arranged between the touch layer and the substrate; and
a phase retardation film arranged to a bottom surface of the substrate; an angle between axes of the top linearity polarizer film and a phase retardation of the touch layer being approximate half an orthogonal angle; an angle between axes of the bottom phase retardation film and the upper phase retardation of the touch layer being approximate an orthogonal angle.
